(19) United States
(12) Patent Application Publication
(10) Pub. No.: US 2002/0188720 A1
(43) Pub. Date: Dec. 12, 2002

(54) METHOD AND APPARATUS FOR DYNAMICALLY CONTROLLING THE PROVISION OF DIFFERENTIATED SERVICES

(76) Inventors: WILLIAM F. TERRELL, TYNGSBORO, MA (US); JAMES V. LUCIANI, CONCORD, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/222,340

(22) Filed: Dec. 28, 1998

(51) Int. Cl. G06F 15/173

(52) U.S. Cl. 709/225

(57) ABSTRACT

An apparatus comprising a network interface, through which the apparatus facilitates communication between a client device and a remote device and a controller is presented. In accordance with one aspect of the present invention, the controller, coupled to the network interface, dynamically creates and removes admission filters based, at least in part, on an admissions profile that, when triggered, the filter(s) initiate an admission control decision preventing premature allocation of resources which are not used or authorized.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise expressly reserves all rights whatsoever in said copyright works.

### BACKGROUND OF THE INVENTION

1. Field of the Invention

The present invention relates to the field of data networking and, in particular, to a method and apparatus for dynamically controlling the provision of differentiated services.

2. Background Information

As computer technology has evolved, so too has the use of networks which communicatively couple computer systems together enabling them to communicate with one another. One of the more popular of such computer networks is colloquially referred to as the Internet, which is an internetworking of a number of publicly accessible networks and servers distributed throughout the world. The Internet provides the communication means by which individual enterprise networks (e.g., Local Area Networks (LANs), Wide Area Networks (WANs), and the like), servers and other network devices communicate with one another. Individually, the networks/servers comprising the Internet come in many different topologies, employing a corresponding number of alternative communication technologies. One of the profound advantages of the Internet is that communication at the network layer is standardized around a standard set of communication protocols commonly referred to as the Internet communication suite. By adhering to the Internet communication suite, any network device can communicate with any other network device, effectively creating a single, seamless ubiquitous network.

Once the domain of government agencies and academic institutions, the Internet has grown to become a form of entertainment in many parts of the world, as well as a source of commerce. However, the increased popularity of the Internet has also revealed some of its limitations. One such limitation is bandwidth management. That is to say, the increased popularity of the Internet has resulted in increased congestion, for which the Internet is ill-equipped to manage.

One reason for the Internet's limited ability to manage congestion centers around its “best-effort” service level paradigm. Simply stated, in communicating data packets from one network device to another, each intervening network device processes data traffic in the order in which it was received and selects the best route currently available to deliver the data packets to its destination. If a network device is overburdened, or the data packets are corrupted in transit (e.g., due to noise or other factors), the data packets may be dropped requiring re-transmission. While dropped or re-transmitted data packets are not a problem for many applications, it does pose a problem for multimedia applications executing over the Internet. Moreover, the best-effort service level of the Internet does not take into account that certain data packets are more time-sensitive than others.

To illustrate this last point, consider for example computer telephony applications, the so-called Internet telephones. The speech quality and cognition provided by computer telephony applications are heavily dependent upon a network's ability to transmit data packets from the source to the destination in a near real-time fashion, without dropping packets or otherwise requiring re-transmission. Dropped or re-transmitted data packets may well result in choppy, unintelligible speech at the receiving end of the communication.

To overcome the limitations of the best-effort service paradigm, the Internet Engineering Task Force (IETF), an association of networking professionals, have proposed inclusion of differentiated services in the Internet standard, providing different levels of service within the bandwidth of the Internet. Differentiated services enable an application/network device/enterprise network/etc, to reserve communication bandwidth with which to facilitate transmission of data packets between a source and destination. Those skilled in the art will recognize that reserving bandwidth using the differentiated services paradigm comes at a cost. That is, Internet Service Providers (ISP) and other Internet access points charge a premium to secure and dedicate bandwidth to individual clients/applications. Even if there is not a per-use cost associated with the use of differentiated services, there is an inherent cost in dedicating equipment on a per-port basis to support such differentiated services. Consequently, simply adding more ports to alleviate congestion and provide differentiated services is a costly solution.

To more effectively manage the costly resources required to provide differentiated services, it is known to install filters on network edge devices which control the provision of differentiated services. Thus, rather than simply dedicating bandwidth to support a service level between two networks, a such bandwidth is not allocated until such time as network traffic satisfying filter criteria is detected. One skilled in the art will appreciate, however, that the network devices can quickly become over-burdened with such filters.

Thus, a method and apparatus for dynamically controlling the provision of differentiated services is presented, unencumbered by the deficiencies and inherent limitations commonly associated with the network devices of the prior art. It will be apparent to those skilled in the art, from the description to follow, that the present invention achieves these and other desired results.

### SUMMARY OF THE INVENTION

In accordance with the teachings of the present invention, a method and apparatus for controlling access to a network information source is provided. In particular, in accordance with one embodiment of the present invention, an apparatus comprising a network interface, through which the apparatus facilitates communication between a client device and a remote device and a controller is presented. In accordance with one aspect of the present invention, the controller, coupled to the network interface, dynamically creates and removes admission filters based, at least in part, on an admissions profile such that, when triggered, the filter(s) initiate an admission control decision preventing premature allocation of differentiated services resources which are not used or authorized.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a block diagram of an example data network within which the teachings of the present invention may be practiced, in accordance with one embodiment of the present invention;

FIG. 2 illustrates a block diagram of a network device incorporating the teachings of the present invention, in accordance with one embodiment of the present invention;

FIG. 3 illustrates a flow chart of an example method for dynamically controlling the provision of differentiated services, in accordance with one embodiment of the present invention;

FIG. 4 illustrates an example communication packet suitable for use in the example network of FIG. 1, in accordance with one embodiment of the present invention;

FIG. 5 graphically illustrates an example profile database from which trigger filters and admission profiles are dynamically generated, in accordance with one embodiment of the present invention; and

FIG. 6 illustrates a block diagram of an example network device incorporating the teachings of the present invention, in accordance with an alternate embodiment of the present invention.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers and configurations are set forth in order to provide a thorough understanding of the present invention. However, it will also be apparent to those skilled in the art that the present invention may be practiced without these specific details. In other instances, well known features are omitted or simplified for clarity.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise expressly reserves all rights whatsoever in said copyright works.

In alternative embodiments, the present invention may be applicable to implementations of the invention in integrated circuits or chip sets, wireless implementations, switching systems products and transmission systems products. For purposes of this application, the terms switching systems products shall be taken to mean private branch exchanges (PBXs), central office switching systems that interconnect subscribers, toll/tandem switching systems for interconnecting trunks between switching centers, and broadband core switches found at the center of a service provider's network that may be fed by broadband edge switches or access multiplexers, and associated signaling, and support systems and services. The term transmission systems products shall be taken to mean products used by service providers to provide interconnection between their subscribers and their networks such as loop systems, and which provide multiplexing, aggregation and transport between a service provider's switching systems across the wide area, and associated signaling and support systems and services.

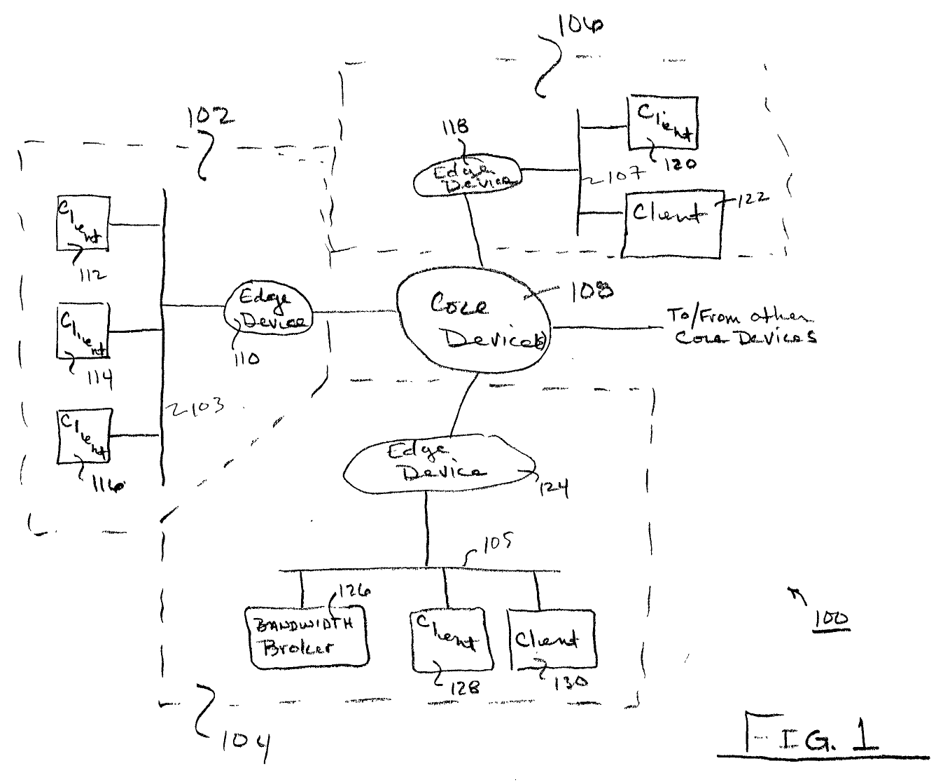

Turning to FIG. 1, an example data network within which the teachings of the present invention are practiced is presented, in accordance with one embodiment of the present invention. In accordance with the illustrated example embodiment of FIG. 1, data network 100 is shown comprising a plurality of clients (112, 114, 116, 120, 122, 128 and 130) communicatively coupled to a network core device 108 via a network edge device (110, 118, and 124) as shown. Those skilled in the art will appreciate, from the description to follow, that network edge devices 110, 118 and/or 124 incorporating the teachings of the present invention dynamically provision the differentiated services offered by and through core device(s) 108 on an as-needed, as-authorized basis, thereby minimizing the resources required of the network edge device and the network to support differentiated services. More specifically, network edge devices 110, 118 and/or 124, in conjunction with a bandwidth broker, dynamically create and remove filters that, when triggered, initiate an admission decision controlling provision of and access to the differentiated services of data network 100. Accordingly, a network device incorporating the teachings of the present invention ensures that the differentiated services of data network 100 are not provisioned until they are needed and authorized, thereby preventing the allocation of unused network resources and reducing the operating cost of data network 100. These and other aspects of the present invention will be apparent to those skilled in the art based on the description to follow.

As depicted in FIG. 1, client computers 112, 114 and 116 are coupled to a common network 103, which is coupled to core device 108 via network edge device 110. In one embodiment clients 112, 114 and 116 along with network edge device 110 form a local area network (LAN) 102. Similarly, clients 128 and 130, bandwidth broker 126 and network edge device 124, coupled via network 105 form LAN 104, while clients 120 and 122 coupled to network edge device 118 via network 107 form LAN 106. As shown, each of LANs 102, 104 and 106 are coupled to a common network core device, e.g., core device 108. In one embodiment, the combination of LANs 102, 104 and 106 coupled to a common core device 108 form a domain of an enterprise-wide network, also commonly referred to as a wide area network (WAN) or wide area information system (WAIS). In an alternate embodiment, core device 108 is one of a plurality of network core devices comprising a global data network, e.g., the Internet.

As depicted, example data network 100 of FIG. 1 is much like the typical prior art network described above, with the notable exception that access filters are dynamically established and removed on network edge devices 110, 118 and 124, incorporating the teachings of the present invention, to control access to the differentiated services offered by core device 108. The filters are installed on an as-needed, as-authorized basis, thereby preserving network resources as well as filter resources of the network edge device. Accordingly, those skilled in the art will appreciate that data network 100 is intended to represent any of a number network architectures employing any of a number of alternative communication protocols known or anticipated in the art. Thus, except for the teachings of the present invention to be described more fully below, as used herein the term network device is broadly employed to describe any of a number of alternative network devices commonly known and used in the data networking arts to support communication between network elements.

As used herein, bandwidth broker 126 of LAN 104 controls provision of differentiated services at a network level for the domain associated with core device 108. Accordingly, bandwidth broker maintains “bandwidth pools” for each class of service supported by network core device 108. In accordance with one embodiment of the present invention, bandwidth broker 126 also maintains an admission policy database, which correlates subscribed services to admission filters and classifier profiles that, when triggered, are installed on or removed from network edge devices incorporating the teachings of the present invention, as appropriate. Thus, in accordance with one aspect of the present invention, bandwidth broker 126 creates and removes admission filters (also referred to as access filters, or policy filters) and classifier profiles on network edge devices incorporating the teachings of the present invention, e.g., 110, 118 and/or 124 to control provision of the differentiated services offered by core device 108. Although depicted as a separate entity, those skilled in the art will appreciate from the description to follow that bandwidth broker 126 may well be integrated with one or more of network edge devices 110, 118 and/or 124.

As used herein, clients, e.g., 112, 114, 116, 120, 122, 128 and/or 130 are intended to represent any of a number of alternative computing devices known in the art. In one embodiment, for example, clients are typical desktop computers coupled to subnetworks as is well known in the art. In an alternate embodiment, clients are the so-called network computers, i.e., computers which rely on a network server for application support and hard drive storage. In an alternate embodiment, client 102 is an electronic appliance, e.g., a webTV™ Internet Terminal available from Sony Electronics, Inc. of Park Ridge, N.J., that enables one to utilize the resources of data network 100 without the need of a full-featured computer system.

In accordance with the illustrated example data network of FIG. 1, core device(s) 108 is intended to represent any of a number of core network devices known to those skilled in the art which provide differentiated service levels of communication. In one embodiment, for example, core device 108 is a network switching center comprising a number of switches, hubs, routers and servers. In an alternate embodiment, core device 108 is a switch. In an alternate embodiment, core device 108 is a server supporting network switching and communications.

Similarly, the communication links illustrated in FIG. 1 may be any of a wide range of conventional wireline and wireless communication media, and may be different for different clients, servers, bandwidth brokers and other network devices. For example, a communication link may be a cable, a fiber optic cable, or may represent a nonphysical medium transmitting electromagnetic signals in the electromagnetic spectrum. Additionally, a wireless communication link may also include any number of conventional routing or repeating devices, such as satellites or electromagnetic signal repeaters or basestations. Irregardless of the form of communication medium, data is typically transferred between network elements using any of a number of data communication protocols. In accordance with such data communication protocols, data is generally transferred between network elements in units commonly referred to as packets, frames, datagrams and the like. Typically, each packet includes data, a source address and a target address. As will be described in greater detail below, additional control information, generally included in a header, may also be included in the packet. The number of bytes of data contained within a packet is dependent upon the communication resources of the client, the host and the network protocol employed.

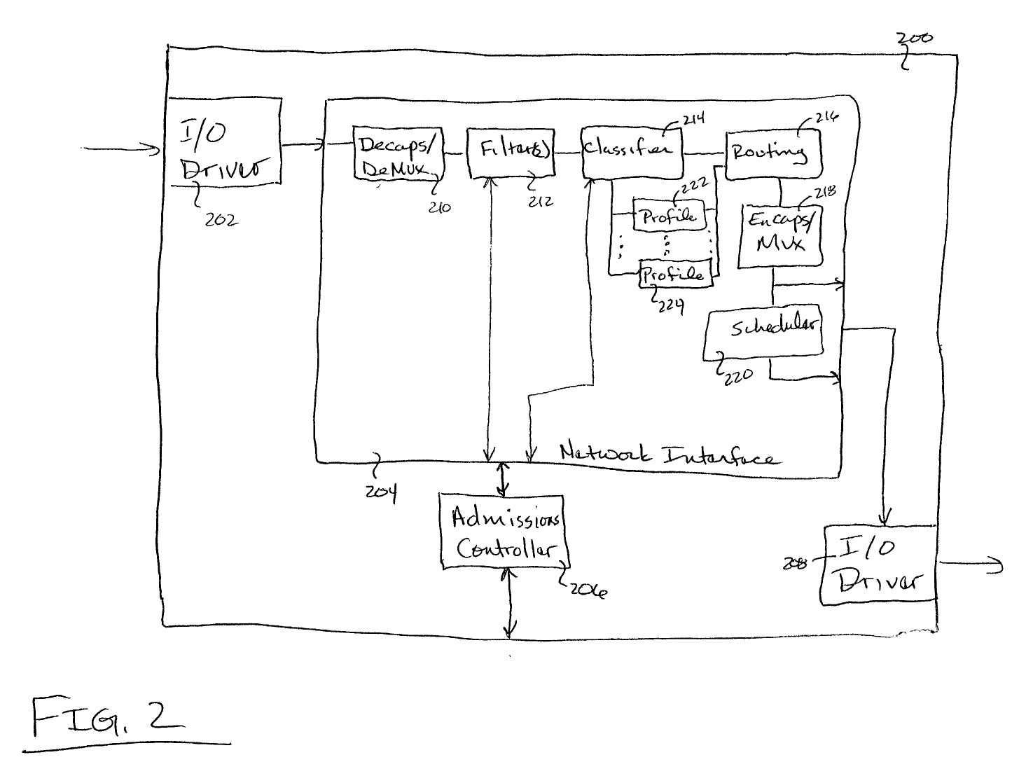

Having introduced the operating environment for the present invention, a block diagram of an example network edge device incorporating the teachings of the present invention is provided with reference to FIG. 2. As depicted, FIG. 2 illustrates a block diagram of an example network device 200 incorporating the teachings of the present invention, in accordance with one embodiment of the present invention. In one embodiment, network device 200 may well be beneficially incorporated into network 100 as one or more of network edge devices 110, 118 and/or 124. Further, as alluded to above, except for the teachings of the present invention, network edge device 200 is intended to represent any of a number of alternative network devices commonly used and known in the art. Thus, those skilled in the art will appreciate that the present invention may be practiced in any of a number of alternate embodiments without deviating from the spirit and scope of the present invention.

As presented in the example embodiment of FIG. 2, network device 200 is shown comprising input/output drivers 202 and 208, network interface 204 and controller 206 coupled as shown. In accordance with one aspect of the present invention, to be developed more fully below, controller 206 controls the dynamic provision of filters 210 and classifier profiles 222 providing access to the differentiated services offered within the domain of resident core device(s). Although depicted as separate entities, those skilled in the art will appreciate that this is for ease of explanation only, and that controller 206 may well be incorporated as a functional block of network interface 204. In an alternate embodiment, controller 206 may well be remotely located and communicatively coupled to network device 200 and network interface 204. As used herein, controller 206 is intended to represent any of a number of microprocessors, microcontrollers, programmable logic devices (PLDs), application specific integrated circuits (ASICs) and the like.

As depicted in FIG. 2, I/O drivers 202 and 208 provide the physical interface between network device 200 and the client network and core network, respectively. That is, I/O driver 202 provides an interface supporting data communication (bi-directional) with clients, e.g., client 112, while I/O driver 208 provides an interface supporting data communication (also bi-directional) with core devices, e.g., core device 108. Such I/O devices are well known in the art and need not be further described here.

In accordance with the illustrated example embodiment of FIG. 2, network interface 204 is shown comprising Decaps/DeMUX unit 210, filter(s) 212 classifier 214 including profiles 222, routing unit 216, Encaps/Multiplexer (MUX) 218 and scheduler 220, each communicatively coupled as shown. As shown, Decaps/DeMUX 210 receives data packets from a communicatively coupled network via I/O driver 202 and translates the data packets from the communication protocol employed by the network.

Filter(s) 212 and classifier 214 are employed to identify incoming data traffic adhering to admission policy criteria and marks the data packets with an appropriate routing classification in accordance with a predetermined differentiated services admission policy. That is, filter 212 provides an indication, or trigger, denoting when data packets are received that satisfy filter criteria. In accordance with one aspect of the present invention, the filters populating filter(s) 212 are dynamically provisioned on network interface 204 by controller 206 in accordance with a admission control policy. In one embodiment, controller 206 creates and removes specific filters from filter 212 in response to control messages from a remote bandwidth broker, e.g., bandwidth broker 126. In an alternate embodiment, controller 206 is a bandwidth broker and creates/removes specific filters from filter 212 on its own accord, in furtherance of a admission control policy. Once in place, filter 212 issues a trigger message to controller 206 when data packets are received satisfying the criteria of an installed filter.

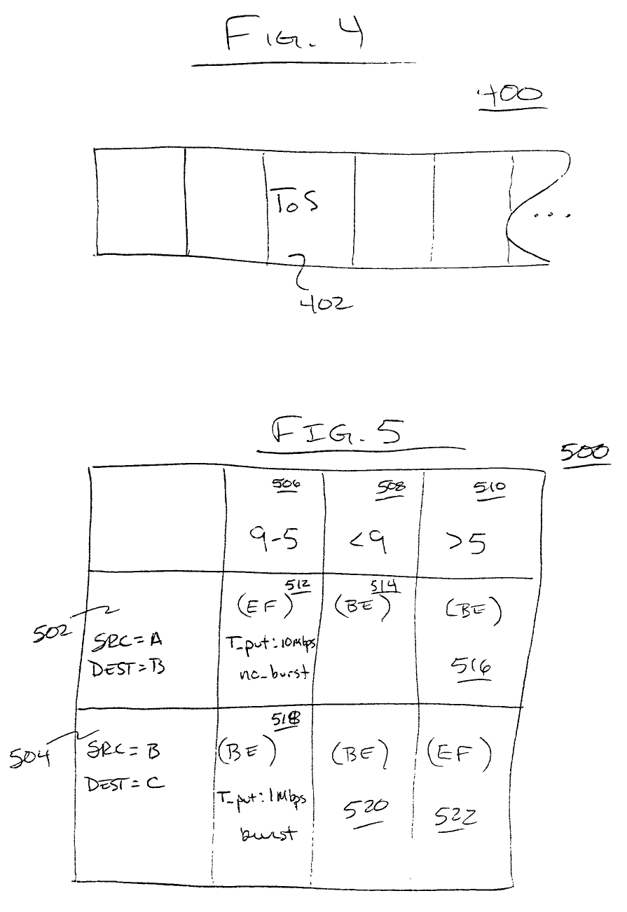

Classifier 214 functions to classify and mark data packets in accordance with their service level. In operation, once a trigger is received denoting receipt of data packets satisfying the filter criteria of at least one filter 212, controller 206 updates the installed profiles 222 of classifier 214 such that any data packets received at classifier 214 satisfying at least one profile 222 will be marked in accordance with their subscribed service level. More specifically, in accordance with one embodiment of the present invention, the Type of Service (ToS) field in a “header” appended to the data packet is marked to denote an appropriate level of service for transmission of the data packet. One example of a header is provided with reference to FIG. 4.

Turning briefly to FIG. 4, a graphical illustration of an example header 400 suitable for use in conjunction with the present invention is depicted. As shown, in accordance with the illustrated example embodiment, header 400 is a byte wide, containing up to eight separate data fields. Of particular interest with respect to the present invention is the Type of Service (ToS) field 402. Those skilled in the art will appreciate that the number of bits allocated to ToS field 402 determines number of service gradations supported by header 400. In accordance with the illustrated example embodiment, the ToS field 402 is a one-bit field. Consequently, ToS field 402 can be marked to differentiate two levels of service, associated with a ToS field 402 entry of ‘0’ or ‘1’. In one embodiment, for example, a ToS field 402 populated with a ‘0’ denotes a best-effort service level. Accordingly, when data packets are received which do not satisfy filter criteria, classifier 214 updates the ToS field 402 of the header appended to such data packets with a ‘0’. Alternatively, as will be described in greater detail below, receipt of data packets satisfying filter 212 criteria may result in marking the ToS field 402 of the header appended to such data packets with a ‘1’, denoting an expedited forwarding (EF) level of service. Those skilled in the art will appreciate that larger ToS fields 402 will enable header 400 to support increased gradations in service levels. Indeed, the number of service levels may increase exponentially as the number of bits allocated to ToS field 402 increases.

Returning to FIG. 2, in accordance with one aspect of the present invention, the provision of profiles 222 to classifier 214 by controller 206 is closely monitored. That is, profiles 222 are created by controller 206 to satisfy individual flows, e.g., transmission of a number of related data packets, and are summarily removed when the flow no longer exists. Accordingly, a network device such as network device 200 incorporating the teachings of the present invention minimizes the resources dedicated to support filters and classifier profiles by allocating resource to only those filters/classifier profiles currently in use.

In addition to the foregoing, network interface 204 includes routing unit 216, Encaps/MUX 218 and scheduler 220, as shown. Routing unit 216 identifies and marks the data packets with routing information in accordance with the subscribed service level. Encaps/MUX 218 places the data packets in the proper format for transmission over the data network. Scheduler 220 is used to schedule transmission of data packets through I/O driver 208 in accordance with their subscribed service level, if congestion on the outgoing communication link is detected. Thus, those skilled in the art will appreciate that routing unit 216, Encaps/MUX 218 and scheduler 220 are typical of those used in the data networking art and, thus, need not be further described.

Thus, in accordance with one aspect of the present invention, controller 206 dynamically controls the provision of filters 212 and classifier profiles 222 in accordance with a differentiated services admission policy, thereby reducing the resources dedicated to support differentiated services.

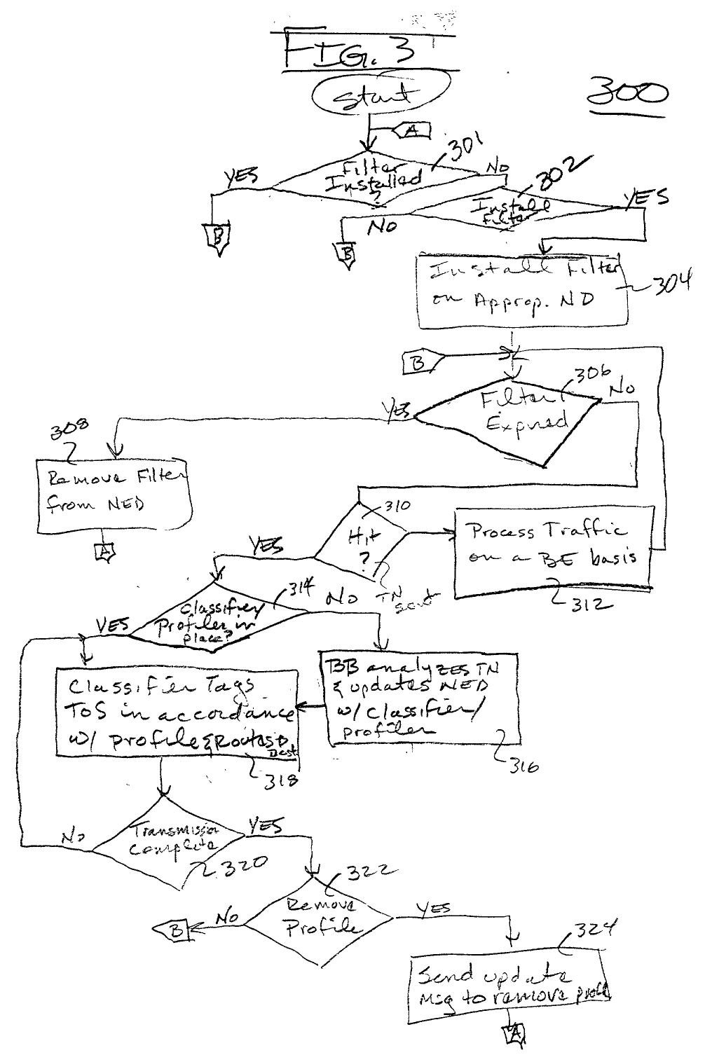

Given the foregoing architectural description, the operation of example network device 200 incorporating the teachings of the present invention will now be developed with reference to the flow chart depicted in FIG. 3. In particular, an example method for dynamically controlling the provision of differentiated services in a data network will be developed with reference to the flow chart depicted in FIG. 3, in accordance with one embodiment of the present invention.

For ease of explanation, and not limitation, the example method depicted in FIG. 3 will be developed in accordance with an example communication session with continued reference to FIGS. 1 and 2. Consider the following, a corporate entity has a number of distributed sites, each having their own respective local area network, e.g., LANs 102, 104 and 106. In order to link these remote sites, the corporate entity has contracted with an internet service provider (ISP) to provide premium network services between LAN 102 and LAN 106 between the hours of 9 AM and 5 PM via its network core device 108.

With reference to FIG. 3, the example method for controlling the provision of differentiated services of core device 108 begins when data packets are received by a network edge device, e.g., network edge device 110, with an initial determination of whether a filter corresponding to the received data packets is installed, 301. If not, a further determination is made of whether a filter need be installed on a network edge device, block 302.

In accordance with the above example implementation, bandwidth broker 126 determines at 9 AM that differentiated services have been contracted for between LAN 102 and LAN 106 and issues a setup message to install the appropriate filter on an appropriate network edge device, block 304. More specifically, bandwidth broker 126 issues a command to controller 206 of network edge device 110 incorporating the teachings of the present invention to install a filter in filter(s) 212. In one embodiment, the newly installed filter issues a trigger when a source of LAN 102 (e.g., clients 112, 114 and/or 116) and a destination of LAN 106 (e.g., clients 120 or 122) are denoted in the received data packets.

In block 306, a determination is made as to whether any of the installed filters of filter(s) 212 have expired. If so, they are removed from the appropriate network edge device at block 308. Thus, in accordance with one aspect of the present invention, a network edge device incorporating the teachings of the present invention allocates only those resources necessary to support filters that are currently needed, thereby reducing the overall amount of resources required of the network device. If the filter has not expired, however, it continues to monitor received data packets for a “hit”, e.g., a received data packet which satisfies the filter criteria (e.g., source from LAN 102 and destination within LAN 106), block 310. If the received data packets do not satisfy the filter criteria at 310, they are processed in accordance with the best-effort service paradigm, 312. That is, if data packets are received which do not adhere to a subscribed service level, the ToS field 402 of the header 400 appended to the data packets is marked by classifier 214 to denote a best-effort service level.

If, however, the received data packets satisfy at least one installed filter 212 at 310, a further determination is made by controller 206 of whether an appropriate classifier profile 222 is installed in classifier 214 to appropriately mark the data packets in accordance with their subscribed service level, 314. If controller 206 determines that the necessary profile 222 is not installed, controller 206 forwards the trigger notification received from filter 212 to bandwidth broker 126 which correlates the trigger notification with the appropriate classifier profile, and issues an update message to classifier 214 via controller 206, block 316. In one embodiment, in response to receiving a trigger notification from controller 206, bandwidth broker 126 looks up the received trigger in the admissions policy database to identify an associated classifier profile 222, 316. Once the appropriate classifier profile 222 is identified it is sent to classifier 214 via controller 206 in an update message. Once the appropriate profile 222 has been installed in classifier 214, classifier 214 marks the ToS field 402 of header 400 appended to the received data packets in accordance with their subscribed service level. In one embodiment, for example, ToS field 402 is marked to denote a best effort service level, and the data packets are subsequently routed in accordance with their subscribed service level 318. At 320, a determination is made of whether transmission is complete. If not, the method continues with block 318.

If transmission is complete, controller 206 makes a determination of whether to remove the classifier profile 222. In one embodiment, for example, controller 206 makes this determination in accordance with the service level it supports. For example, if profile 222 supports the highest service level, and the filter has not yet expired for that service level, controller 206 maintains the profile to support the service level with minimal delay. If however, profile 222 corresponds to a lower service level, controller 206 may remove the profile, even though the corresponding filter remains in place, to liberate network interface 204 resources. If, in 322, a determination is made to remove the filter, controller 206 instructs classifier 214 to purge filter 222, and an update message is sent to bandwidth broker 126 denoting the update. Subsequently, the process continues with

Thus, in accordance with the above example, controller 206 is responsible for the provision of filters 212 and classifier profiles 222 necessary to support differentiated services via network edge device 110. In one embodiment, controller 206 relies on the information provided by a remote bandwidth broker 126 or some other policy server. In an alternate embodiment, controller 206 accesses a co-located admission policy database autonomously. Irregardless of where the admissions policy database is located, access to the differentiated services of core device 108 is dynamically controlled through the selective provision of trigger filters and classifier profiles on network devices, e.g., network device 110, as appropriate.

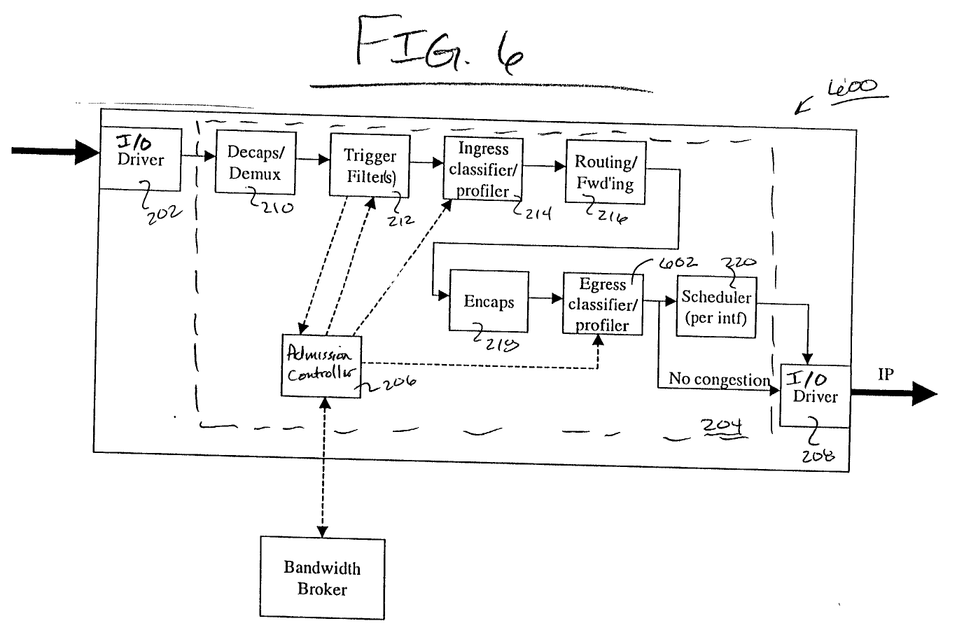

Thus, one method for implementing the teachings of the present invention has been described with reference to FIGS. 1-4. Those skilled in the art will appreciate, however, that modifications and alterations to the network topology, header size, network elements and differentiated services admission policy can be made without deviating from the spirit and scope of the present invention. For example, in addition to the teachings above in FIG. 3, controller 206 may install or remove filter(s) 212 or classifier profiles 222 based on time of day, received network traffic, and any of a number of core network operating parameters (e.g., identified faults, etc.). Indeed, such modifications and alterations to the above description are anticipated within the spirit and scope of the present invention. Having described an example network device incorporating the teachings of the present invention with reference to FIG. 2, and a method of operation in FIG. 3, one embodiment of an example admission profile database is provided with brief reference to FIG. 5. Accordingly, FIG. 5 illustrates an example two-dimensional admission profile database 500, wherein a network administrator establishes the filters and profiles for admission to be provisioned on appropriate network devices controlling access to differentiated services. Although represented as a two-dimensional database, those skilled in the art will appreciate that this is of ease of explanation only, and that a database of greater or lesser complexity may well be substituted for database 500 without deviating from the spirit and scope of the present invention.

With reference to FIG. 5, example admission profile database 500 is shown comprising classifiers 502 and 504 and associated profiles 512-522 differentiated based on time of day indicators 506, 508 and 510. In accordance with the illustrated example embodiment, the filter established on a network edge device corresponds to an appropriate one or more of classifiers 502 and 504, such that the filter associated with classifier 502 monitors received network traffic for data packets emanating from network A (e.g., LAN 102) destined for network B (e.g., LAN 106). Accordingly, when a hit is received corresponding to classifier 502 during the hours of 9-5, profile 512 will be installed in classifier 214 of network edge device 110 of LAN 102 to mark data packets satisfying the filter criteria in accordance with their subscribed service level. In accordance with the information provided by admission control policy database 500, such packets are marked for expedited forwarding (EF) with a throughput rate of 10 Mbps, no burst in accordance with profile 512. Packets corresponding to classifier 502 received before 9 AM or after 5 PM will be marked for best-effort delivery, in accordance with profiles 514 and 516. Similarly, profiles 518-522 denote service level support for network traffic defined by classifier 504. Thus, a network device incorporating the teachings of the present invention installs and removes filters and classifier profiles, defined in an admission policy database, on an as-needed, as-authorized basis, thereby limiting the network and device resources dedicated to supporting the differentiated services of an associated data network.

Turning next to FIG. 6, an alternate embodiment of an example network device incorporating the teachings of the present invention is presented. Those skilled in the art will recognize that example network device 600 is similar to that of network device 200 presented above, with the notable exceptions that controller 206 is depicted integrated with network interface 204 and the addition of egress classifier/profiler 602. Thus, those skilled in the art will appreciate that network device 600 controls the provision of differentiated services by dynamically installing/removing trigger filters and classifier profiles in accordance with an admission control policy. In doing so, network device 600, like network device 200 described more fully above, reduces the amount of network and management resources required to support the differentiated services, thereby reducing the overall cost associated with supporting such services.

In addition to the embodiments described above, those skilled in the art will appreciate that the teachings of the present invention may well be integrated with a single integrated circuit (not shown). That is, those skilled in the art will appreciate that advances in IC fabrication technology now enable complex systems to be integrated onto a single IC. Thus, in accordance with one embodiment of the present invention, the teachings of the present invention may be practiced within an application specific integrated circuits (ASIC), programmable logic devices (PLD), microcontroller, processor and the like.

While the innovative features for controlling access to network information sources of the present invention have been described in terms of the above illustrated embodiments, those skilled in the art will recognize that the invention is not limited to the embodiments described. The present invention can be practiced with modification and alteration within the spirit and scope of the appended claims. In particular, the present invention may be practiced with other features and/or feature settings. Particular examples of other features include but are not limited to transaction communication protocols and architectural attributes. Accordingly, the description is to be regarded as illustrative instead of restrictive on the present invention.

Thus, alternate methods and apparatus for dynamically controlling the provision of differentiated services incorporating the teachings of the present invention have been described.

What is claimed is:

1. An apparatus comprising:
a network interface, through which the apparatus facilitates communication between a client device and a remote device at any of a number of alternative service levels; and
a controller, coupled to the network interface, to dynamically create and remove filters controlling access to the different service levels based, at least in part, on an admissions profile.

2. The apparatus of claim 1, wherein the filter(s), when triggered, initiate an admission control decision preventing premature allocation of service level resources which are not yet required or authorized.

3. The apparatus of claim 2, wherein the filters are triggered by information contained within received data packets.

4. The apparatus of claim 3, wherein the filters are triggered by one or both of packet source information and packet destination information.

5. The apparatus of claim 1, wherein the admissions profile is stored in a communicatively coupled remote device.

6. The apparatus of claim 5, wherein the communicatively coupled remote device is a bandwidth broker or other generic policy server.

7. The apparatus of claim 1, wherein the admissions profile is available locally within the apparatus.

8. The apparatus of claim 1, wherein the controller establishes an ingress profile in response to detecting an associated trigger event, wherein the ingress profile modifies the received data packets adhering to the filter criteria to denote a particular service level, in accordance with the admissions profile.

9. The apparatus of claim 8, wherein the controller removes ingress profiles when data packets adhering to the filter criteria are no longer received, liberating apparatus resources.

10. The apparatus of claim 8, wherein the controller removes ingress profiles after a predetermined period of time, liberating apparatus resources.

11. The apparatus of claim 1, wherein the controller removes filters in accordance with a network administration policy.

12. The apparatus of claim 11, wherein the controller removes filters based, at least in part, on time-of-day.

13. A method for controlling provision of differentiated services in a data network, the method comprising:
(a) installing a filter on a network edge device to provide a trigger notification upon detecting data packets adhering to filter criteria, in accordance with a network administration policy; and
(b) dynamically creating an ingress profiler which polices admission to a particular service level.

14. The method of claim 13, further comprising (c) marking the received data packets adhering to the filter criteria according to a subscribed service level.

15. The method of claim 13, wherein the ingress profiler polices admission to a particular service level by allowing only those received data packets adhering to the filter criteria of a particular service level to proceed at that service level.
